(19) United States
(12) Patent Application Publication
(10) Pub. No.: US 2011/0089233 A1
(43) Pub. Date: Apr. 21, 2011

(54) DEVICE AND PROCESS FOR THE AUTHENTICATION OF AUTHORIZATIONS OR ENABLEMENT OF A PERSON WITH THE USE OF A MOBILE COMMUNICATION DEVICE

(75) Inventor: Johann Kaspar LOCHER, Wetzikon (CH)

(73) Assignee: AIXUM AG, Baden-Dattwil (CH)

(21) Appl. No.: 12/790,651

(22) Filed: May 28, 2010

Related U.S. Application Data
(60) Provisional application No. 61/182,298, filed on May 29, 2009.

(51) Int. Cl. G06K 5/00

(52) U.S. Cl. 235/380

(57) ABSTRACT

An identification document which is linked to a person, particularly for the authentication of authorizations or qualifications of the person is provided. The identification document includes a mobile communication device which is able to show images and assigned to the person, including a display unit, an operating unit and a memory, wherein an identification dataset that is stored in the memory is assigned to data which are stored and administered in a central database, and wherein an optical recognition attribute that is assigned to the identification dataset can be displayed on the display unit of the communication device.

### CROSS REFERENCE TO RELATED APPLICATION

This application claims the benefit under 35 USC 119(e) of the provisional patent application Ser. No. 61/182,298, filed May 29, 2009, which is hereby incorporated by reference in its entirety.

### BACKGROUND OF TUE INVENTION

1. Field of the Invention

The present invention generally involves an identification document that is tied to a person, particularly for authenticating authorizations or enablement of a person, wherein the identification document has at least one optical recognition feature, and is assigned to data which are stored and administered in a central database. The invention further more involves a procedure for the production of such an identification document that is linked to a person, and the use of an identification document for cashless payment. The invention furthermore concerns a Computer program product for validating the optical recognition feature that is shown on the identification document and a computer program for administering and handling identification documents in accordance with the invention.

2. Related State of the Art

Credit and bank cards have been a part of everyday life for many years and are used to pay for wares and services. For payment purposes, the credit card that is required at that time is shown, the data shown on it are usually recorded electronically by reading out a magnetic strip that is located on the card or a chip that is integrated into the card, and sent to a central database of the credit card provider for billing. To confirm the identity of the party making the payment, the holder must usually additionally sign a printed receipt. Credit cards are also used to pay for internet orders, wherein it is naturally not possible to provide a confirmation of identity using a signature. Furthermore, credit cards and bank cards often offer the option of withdrawing cash funds from automated teller machines, wherein identification usually takes place by entering a secret PIN code. This type of payment processing unfortunately offers many opportunities for misuse, so that there are new reports about card theft and card misuse in the media almost every day. This represents an enormous problem not only for the providers of credit cards, but also causes high liability risks to credit card users. It is particularly difficult for the user to prow his faultlessness and that he exercised due diligence in the use of the PIN code when the secret PIN code is discovered.

Both official agencies and private ones also issue identification in a credit card format, since this has a handy format, can easily be produced with computer support, and also offers the option of using security features, such as a hologram, an identification photo or an integrated circuit that is built into the card (smartcard), so that good security against forgery is obtained. Cards are used not only for official documents, such as driver's licenses, social insurance identification or personal identification, but also by companies as identification documents for employees—e.g. for access control systems or as authorization cards for IT systems. As compared to common cards, smartcards offer the additional option of being able to store any desired data on the card.

Another major application field of the check card format consists of cards which are issued by companies in customer binding campaigns to their customers. Customer cards offer customers special advantages in the form of additional gifts, bonuses and other incentives and often also include their own credit card function.

Meanwhile, nearly every consumer now has a large variety of plastic cards from a variety of providers and it is often no longer possible to manage all cards together in one handy wallet or portemonnaie.

Due to the widespread use of the check card format and the therewith associated high turnover, there is a strong incentive for criminals to circumnavigate the security measures of these cards, and use other people's cards for abusive purposes. Current systems often offer only minimal resistance to attackers, since it is often not even necessary to have the physical card in one's possession in order to misuse it, but it is instead often sufficient to possess a copy of the data which are stored on the card. It is comparatively easy to steal these data, for instance by briefly stealing and copying the card, by intercepting internet transactions in which card data are transferred, or by using a so called “card skimmer”. Card skimmers are small electronic reader devices which are placed ahead of the card entry slot of publicly accessible automated teller machines by criminals without blocking the slot. The skimmers read out the magnetic strip of the cards while the cards are being put into the slot of the automated teller machine. The function of the automated teller machine is not obstructed with this process, since the data thieves want the card owner to enter his secret PIN code into the keypad of the automated teller machine. The entry is filmed by a mini-camera which is concealed in the skimmer, so that the entered PIN is recognizable from the filmed images. The skimmers are matched to certain construction types of automated teller machines, and the camera is built into the skimmer so that the automated teller machine's keypad is within the camera's field of view. After some time, the criminals remove the skimmer again, and the therein contained recorded data are evaluated. Using the data, copies of the card can be made with low technical requirements. It is a special problem for the customer who has suffered the theft that this also gives the thieves possession of the valid PIN code, and can use the copy of the card to withdraw money from the card owner's account. It would be desirable to create identification documents which could not be copied, even if a thief had all the data which are stored on the card.

A simpler, but also very widespread method which is used by thieves in order to gain possession of someone else's card and its PIN code is to find out the PIN entry at the automated teller machine or at payment terminals. It is usually not difficult to find out the PIN code, since the keypads on automated teller machines are often so exposed that it is very difficult for the user to enter the PIN in a concealed manner. When the PIN has been determined, the card is unnoticeably stolen by trick theft. The thief or others cooperating with him can then make unauthorized payments or steal money until the theft is noticed and the card is blocked, or until the credit limit is used up or the account is empty. In these cases, the customer is often liable for the entire damage, since the bank assumes that he did not exercise sufficient care in keeping the PIN code secret. It would be desirable to make it possible to enter the PIN code in a less exposed manner than what is possible with current systems.

Another disadvantage of the check card format is that the absence of individual card is often noticed only when the card is to be used. In many cases, there is a long time between the time of the theft and the time at which the theft is noticed, which makes it possible for the thief to cause a large amount of damage before the card can be blocked. There is a need for identification systems whose theft is noticeable to the card owner more quickly than what is currently the case.

The term “mobile communication devices”, as used herein, includes all devices which are not fixed at a particular location and which allow communication with other units. In particular, mobile communication devices are assigned to one or more public, proprietary or private network(s) and preferably communicate wirelessly with the network. Examples of mobile communication devices include mobile telephones, smartphones, PDAs which are equipped with a communications interface, cordless telephones, pagers, radio units, netbooks, etc. Examples of networks include telecommunication networks, particularly mobile broadcasting networks, police and non-police authority radio networks (BOS networks—‘BOS” stands for “authorities and organizations with safety talks”), internet, public and proprietary WLAN networks as well as combinations of several differing networks.

The term “identification document”, as it is used herein, describes any type of combination of attributes which are linked to the identity of a person, and which can be used to draw conclusions regarding the identity of the holder, specific legal properties or authorizations, and/or other circumstances which are linked to the person of the holder. The physical consistency of the identification document is not limited to specific forms; rather, the term includes all combinations of attributes which are usable as identification documents in the wider Sense. In particular, an identification document serves for authenticating authorizations or qualifications of this person.

The term “machine readable code which can be optically shown” describes all types of optically depictable combinations of attributes which can be read in using machine devices such as scanners, cameras, bar code readers etc. and transformed into a digital value by a microprocessor. Examples of optically depictable, machine readable codes include 1D, 2D, 3D and 4D codes. In the case of 1D codes, the optical attributes are only applied in one axis; the best known example of this are the generally common bar codes (such as EAN-13, EAN-8, UPC-A, UPC-B, UPC-C, UPC-D, UPC-E, IAN, JAN, ITF, ISBN, ISSN, Code 39, Code 93, Code 128, etc.). In the case of 2D codes, the optical attributes are applied on two axes, wherein a differentiation is made between stacked 1D codes (also as PDF417, Codablock) and Array codes (e.g. QR-Code, DataMatrix, Aztec-Code). 3D codes have additional color or brightness variations; 4D codes have additional animation, that is, their attributes change over time.

The term “PIN code” generally describes a series of numbers or characters which were made known only to the holder of an identification document, and which is kept secret from third parties. PIN codes which consist of a series of four numbers and which are either previously specified or which can be selected and/or changed by the owner are particularly common.

The term “test value” in association with the current invention describes a parameter which is calculated when a dataset is formed using a formation algorithm from the dataset and which is transmitted to the recipient in the transmission of the dataset, either with it or separately. The recipient can compare a security code that is calculated with the same algorithm with the received test value in order to recognize transmission errors or manipulation of the dataset. Examples of the use of test values include cyclic redundancy testing (CRC value), cryptographic hash functions or secure hash algorithms (HSA).

The term “security code” is herein used for codes which are generated on a random basis and are transmitted to a recipient for one time use. For instance, security codes can be used to confirm the correct receipt of a message which can be activated or decoded with the security code. The security code is transmitted to the recipient separately from the message. In order to intercept a message for abusive use, the attacker would have to intercept both messages—the actual message and the message with the security code. Security can be increased by transmitting the two messages on different channels—for instance, one message through SMS or MMS and the other message via e-mail or mail.

The term “integrity test” as it is used herein describes verification of whether a data set or a code corresponds to a previously specified syntax. An integrity test is done in order to recognize manipulations which were undertaken by third parties on a code. In particular, the integrity of scanned-in, machine readable codes which were created using a formation algorithm can be checked in terms of compliance with syntactic formation rules of the algorithm.

The term “validation” as it is used herein describes the confirmation of the validity of an identification document. An identification document is valid when it is marked as valid in a corresponding database. An identification document can particularly be marked as invalid when an expiry date that is assigned to the identification document has passed, if theft or loss of the document was reported, or if another event, such as non-payment of an invoice, has terminated the validity of the identification document.

The term “block” as it is used within this description means that an identification document has been permanently marked as invalid. Herein it is not important whether the block is only indicated in the central database, or whether the identification document itself is marked as blocked. A blocked identification document is always also invalid.

The term “verify” in relation to the present description refers to the verification of the identity of a person who is carrying out a transaction. For instance, the identity of the person can be verified by asking that person to enter a secret PIN code that is known only to that person.

The term “deactivation” of an identification document as it is used herein refers to the temporary suppression of the functionality of the identification document. A deactivated identification document can generally be reactivated by its owner, for instance through a verification of the identity of the person.

### SUMMARY OF THE INVENTION

The present invention solves the problems as described above by a new type of identification documents which can be shown on the display unit of a mobile communication device. Various aspects of the invention concern an identification document that is linked to a person, processes for the production of an identification document, uses of the identification document for cashless payment, as well as Computer program products which are useful in the validation of the identification document and handling of identification documents in accordance with the invention.

The invention is based on the knowledge that mobile communication devices always have a unique identification (worldwide or within the system limits). In the case of mobile telephones, for instance, this is the telephone number, which (together with the area code) assigns every device a number that is unique worldwide. Through the agreement with the provider, each mobile telephone is additionally always assigned to a (legal or natural) entity. Through the combination of an identification document and a mobile communication device, the embodiments of the invention allow a thus far unobtained level of safety, wherein the cost for the user of the identification document is minimal. The invention can be used in a large variety of fields, for instance for customary identification documents (driver's license, personal identification document, company identification document, student identification document, association identification document, etc.), for credit cards, for customer cards, for access documents, or for identification documents with one time validity, such as entry cards for events or coupons.

The invention offers a high degree of environmental friendliness, since the production of the identification documents does not require either paper or plastic. This also minimizes the costs of production, since the provider must only ensure the design of the identification document. The correspondence between the provider and the user of the identification document can largely or entirely take place through modern communication networks, so that the cost for letter paper, printing, shipping and postal fees is kept to a minimum. The costs which are incurred for digital shipment (such as fees for SMS or MMS) are significantly lower than the costs for mailing via post. Furthermore processing can largely take place in an automated manner, so that the devices and processes in accordance with the invention can also be of interest to providers with low personnel resources and overviewable customer groups.

For the users of the invention, it is beneficial that a nearly unlimited number of different identification documents can be used in a space saving manner with one mobile device. It is possible at any time to carry out permissible changes on the identification documents, wherein this applies both to the user and to the provider.

While the loss of common identification documents often remains unnoticed for a long time, the absence of a mobile communication device such as a mobile telephone, smartphone or PDA, which is used at least several times daily in everyday life, is often noticed by the user after just a few minutes. The critical time for misuse of a stolen identification document which generally lies between the theft and the discovery or report of the theft is therefore reduced to a minimal period of time, so that it is possible to take measures before the Stolen device can be used in an abusive manner.

The processes and devices in accordance with the invention prevent criminals which only possess the data of the identification document from misusing the identification documents, since the security measures in accordance with the invention exclude the data from being usable on their own, without the corresponding mobile telephone. An identification document on a “wrong” mobile unit can be immediately recognized due to the security features. The additional security measures which are described in detail in the description make it possible to create very significant obstacles to abusive use.

The present invention is particularly beneficial in relation to Computer based payment systems. For the provider of the wares and services for which payment is to be made, there is the benefit of a simple change to the new payment system. For instance, an existing bar Code scanner can be quickly adapted to the new payment system through the simple installation of a software (for instance, by installing a Java template on the control unit of the scanner) without any additional hardware requirements.

Payment at vending machines can also be performed with much greater security than what is currently possible in known systems.

Customer card systems can be implemented quickly and simply using the invention. Since the “production” of the customer cards is based solely on digital means, the “entry costs” which providers must come up with for the implementation of a customer card system are extremely low. It would therefore also be possible for small companies and even for individual business persons such as specialized retailers or small internet providers to use the devices and processes of this invention to create their own customer cards, therefore generating benefits which were thus far reserved for large commercial chains.

A first aspect of the invention concerns an identification document which is linked to a person and which consists of a mobile communication device that is able to depict images and is assigned to the person, and which includes a display unit, an operating unit and a memory, wherein the memory stores an identification dataset of data which are stored and administered in a central database, and wherein at least one optical recognition property which is assigned to the identification dataset can be shown on the display unit of the communication device.

In accordance with exemplary designs of the identification documents in accordance with the invention, the optical recognition attribute may consist of an image of an identification document, or the optical recognition attribute may contain a photo of the person. The mobile communication device may advantageously consist of a mobile telephone, a PDA which is suitable for communication, a cordless telephone or a radio unit. The identification dataset and/or the optical recognition attribute can preferably be digitally transmitted, wherein the identification dataset may advantageously consist of a message in accordance with a standard which utilizes at least a proprietary standard of a provider of mobile communication services. The identification dataset may also consist of a message in accordance with a non-proprietary, open standard. In a particularly advantageous manner, the identification dataset may consist of a message in accordance with the Multimedia Messaging Service Standard (MMS message) and the optical recognition attribute may consist of an image that is contained in the MMS message. In addition, the identification dataset and/or the optical recognition attribute may possess copy protection. The optical recognition attribute may include an optically depictable, machine readable code, wherein the machine readable code preferably may contain at least one license code, a unique number that is assigned to the mobile communication device, a PIN code and one or more test values. In a further advantageous embodiment of the invention, the machine readable code may be formed out of at least three test values, wherein one test value is calculated on the basis of two other test values. In an advantageous manner, the identification document may include information about access authorizations and/or credit card information or the identification document may consist of a coupon or an event ticket. In a preferred embodiment of the invention, the identification document may possess an expiry date.

In accordance with an exemplary embodiment of the present invention, a process for the production of an identification document that is linked to a person, particularly for authenticating authorizations or qualifications of this person, is provided. An identification dataset that is stored in the memory of a mobile communication device that is able to depict images and is assigned to the person is assigned to data which are stored and administered in a central database. Furthermore, an optical recognition attribute which is assigned to the identification dataset can be shown on the display unit of the communication device, and the process has the following steps: Entry, updating or completion of personal data in a central database; creation of an identification dataset with an optical recognition attribute on the basis of the personal data; secure transmission of the identification dataset to a mobile communication device that is assigned to the persona activation of the identification dataset by the person; and display of the optical recognition attribute on a display device of the mobile communication device. In an advantageous manner, the process may include the additional steps of creating a machine readable code that can be optically shown on the mobile device and embedding the code into the optical recognition attribute; and/or to form the machine readable code from a license code, a unique number that is assigned to the mobile communication device, a PIN code and one or more test values. In a preferred embodiment, the process may additionally include the following steps: Changes of the PIN code by the person; transmission of the changed PIN to the central database; new creation of the machine readable code; and creation and transmission of a new identification dataset on the basis of the changed data. In addition, the process may include the step of forming the machine readable code out of at least three test values, wherein one test value is at least partially calculated on the basis of two other test values. In terms of other steps, the process may include the transmission, separately from the transmission of the identification dataset, of a message with a security code to the mobile communication device that is assigned to the person, wherein the security code is required in order to activate the identification dataset. Herein the identification dataset may be encoded, wherein the security code may be the code that is required for decoding. In a preferred embodiment of the present invention, the process may additionally include the step of transmitting a confirmation of secure receipt of the identification dataset from the mobile communication device to the central database, and/or, after expiry of an expiry date that is assigned to the document, to create a new identification dataset and transmit it to the mobile communication device, and/or to block the identification document in the central database after notice of a theft or loss of the mobile communication device (that is, to mark it as “invalid”).

As other advantageous steps, the process in accordance with the invention may also include the following steps: Transmission of a message about the blockage of the identification document to the mobile device; and deactivation of the identification document and/or the mobile device. A further advantageous embodiment of the invention intends that the process additionally includes the step of deactivating the identification dataset after a specific period for which the mobile communication device has not been used, wherein the deactivated identification dataset can be reactivated by entering the PIN code. In an advantageous manner, the period of non-use which leads to the deactivation of the identification dataset can be selected by the person.

In accordance with another exemplary embodiment of the present invention, the use of an identification document that is linked to a person for cashless payment is provided, wherein an identification dataset that is stored in the memory of a mobile communication device that is able to display images is assigned to data which are stored and administered in a central database. An optical recognition attribute that is assigned to the identification dataset can be shown on the display unit of the communication device, and its use has the following steps: The owner of the communication device shows the communication device which shows the identification document when making payment; the data which are shown on the optical recognition attribute are transmitted to the central database; the payment is booked to the central database. It is advantageously possible, prior to booking the payment, to verify the identity and/or the credit status of the person online, and/or to check online whether the identification document is blocked in the central database after a report of a theft or loss of the mobile communication device (that is, marked as invalid). In a particularly advantageous manner, the invention makes it possible to equip the optical recognition attribute with an optically depictable, machine readable code, and its use may involve the following steps: Reading in the code by means of a scanner into a payment terminal; and transmission of the read-in code to the central database. In addition, this use may involve the following steps: Transmission of a verification question from the payment terminal to the mobile communication device; entry of a PIN code into the mobile communication device; and transmission of a confirmation message from the mobile communication device to the payment terminal. It is preferably possible in an advantageous manner to send a transmission from the central database to the mobile communication device about the initiated booking. In another advantageous embodiment of the use in accordance with the invention, the identification dataset contains a coupon, wherein the coupon may have a time limited validity.

In accordance with another exemplary embodiment of the present invention, a computer program which runs on a microprocessor is provided for the purpose of validating a machine readable code that can be shown on a mobile communication device which is capable of displaying images and is assigned to a person. The machine readable code includes at least a license code, a number that is uniquely assigned to the mobile communication device, a PIN code and one or more test values, and the microprocessor is at least connected to a scanner and a communication unit. The program carries out the following steps: Receiving a validation question from an external application through the communication device; reading in the machine readable code using the scanner; verifying the integrity of the machine readable code; and transmitting a confirmation of validation to the external application. In an advantageous manner, the program can additionally perform the following steps: Receiving invoice data from the external application; extraction of a license code and a number that is uniquely assigned to the mobile communication device from the machine readable Code; formation of a transaction code from the license code and the uniquely assigned number; and transmission of the transaction code and the invoice data to a central database. The program can preferably also carry out the following steps: After reading in the machine readable code, transmission of a verification question to the mobile communication device, and receiving a verification from the mobile communication device. The integrity test can advantageously include the additional step of decoding the code which was scanned in.

In accordance with another exemplary embodiment of the present invention, a computer program which is executable on a mobile communication device that is capable of depicting images ands assigned to a person is provided for the administration and handling of the identification documents in accordance with the invention. Using the computer program, it is preferably possible to divide several identification documents which are assigned to the person into sub-folders or groups. In addition, the computer program may possess a function for changing the PIN code. It is advantageously possible for the program to destroy or delete identification documents if there is a block prerequisite, wherein the block prerequisite can, for instance, consist of the recognition of an attempt to circumnavigate copy protection without authorization, or the block prerequisite may consist of a message from the central database that the identification document is blocked. Another advantageous embodiment of the invention provides that at least individual identification documents can be temporarily deactivated if the mobile device is not being used after the expiry of a predefined period of time. Deactivated identification documents may be reactivated, for instance, by entering a PIN code. The computer program product in accordance with the invention may furthermore include a function for taking over identification documents from a previously used mobile device to a currently used mobile device.

The order in which the steps of the processes and uses in accordance with the invention are only prerequisites for the use of the process in accordance with the invention when one step is dependent upon another step. In all other cases, the steps can also be processed in another order or in parallel.

### BRIEF DESCRIPTION OF THE DIAGRAMS

Exemplary embodiments of the invention are now described using detailed diagrams, wherein

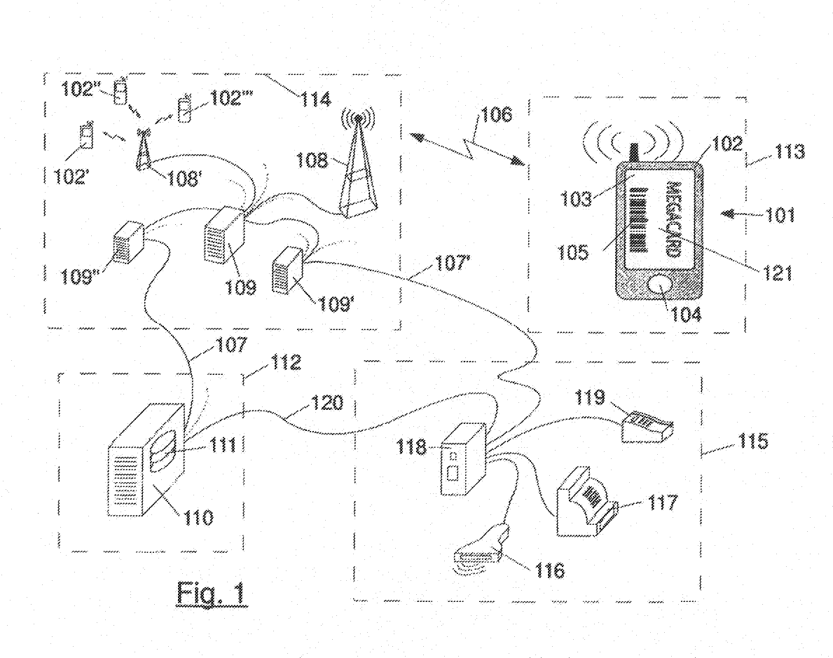

FIG. 1 shows an overview of exemplary networks in which the invention can be advantageously used;

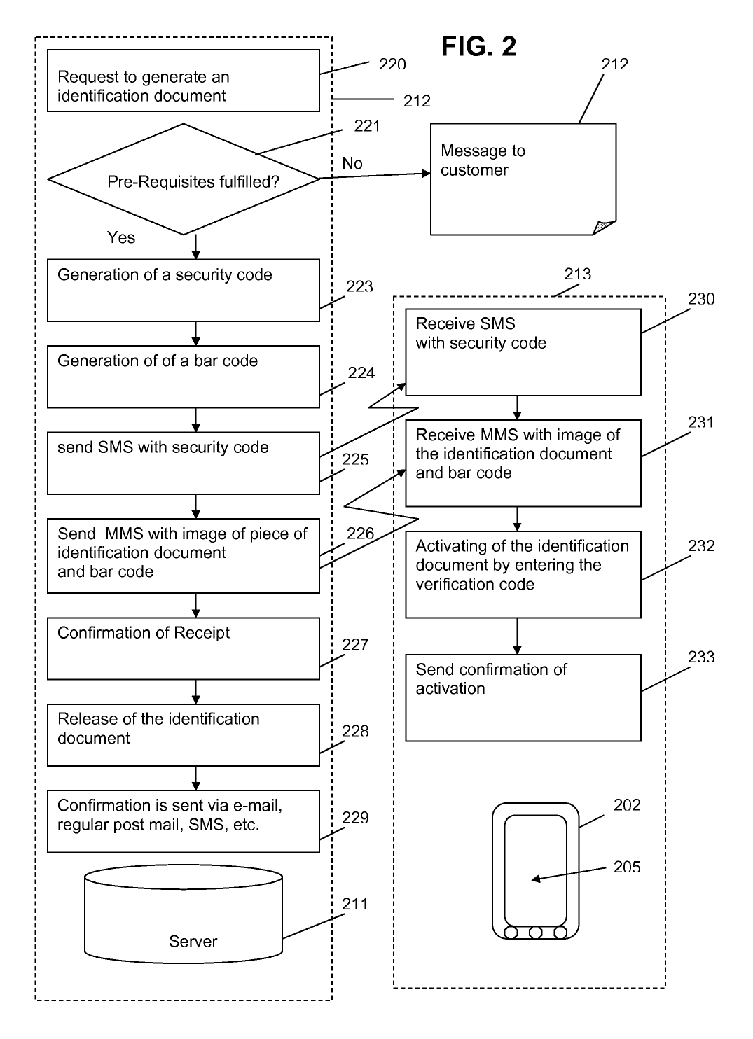

FIG. 2 uses a process diagram to show the steps which are required in an exemplary embodiment of the invention in order to create an identification document in accordance with the invention;

FIG. 3 shows a schematic process diagram of the steps which are carried out in an exemplary payment process in accordance with the invention by various units;

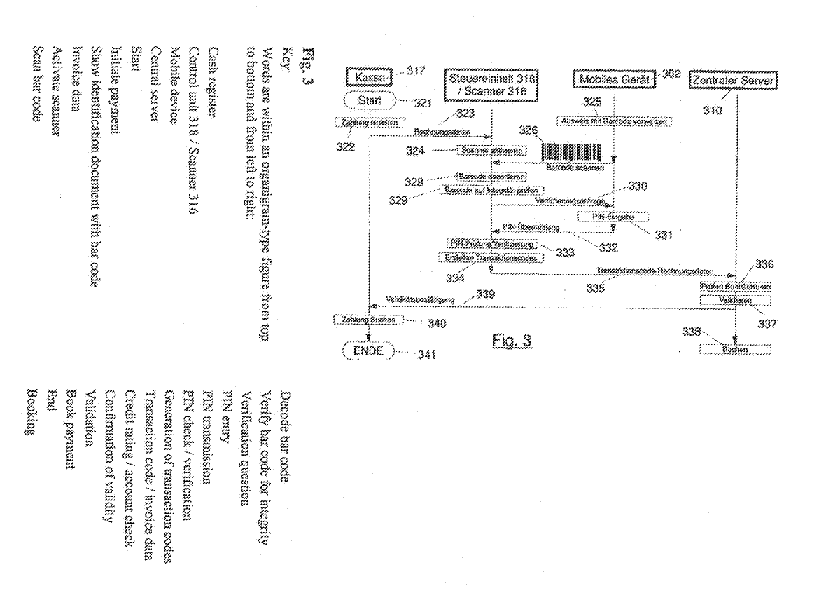

FIG. 4 shows a schematic depiction of the structure of an exemplary optically depictable, machine readable code in accordance with the invention;

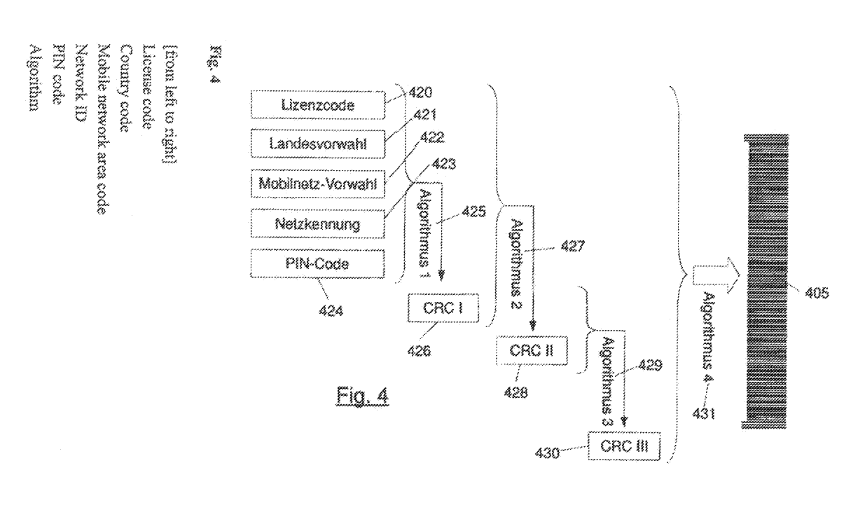

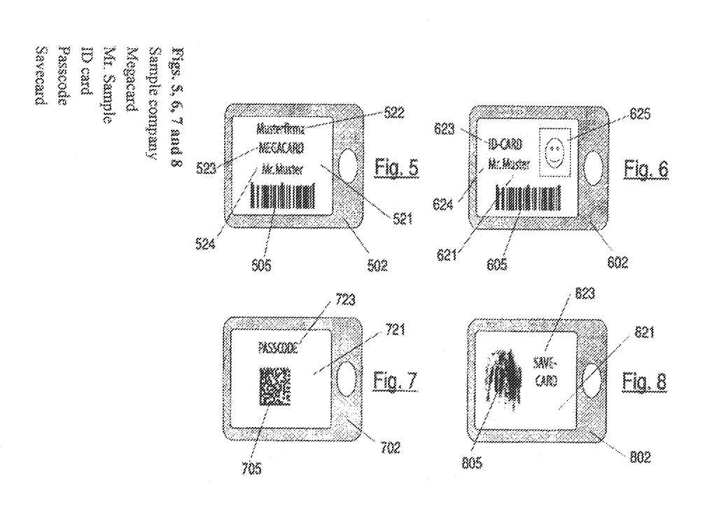

FIG. 5-8 show several exemplary embodiments of identification documents in accordance with the invention; and

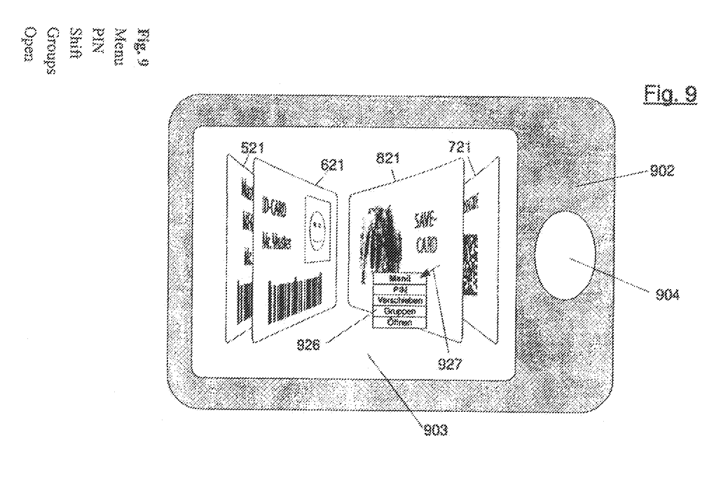

FIG. 9 shows the user interface of a computer program product in accordance with the invention for administering and handling identification documents.

### DETAILED DESCRIPTION OF THE INVENTION

With reference to FIG. 1, the networking of the differing units which participate in various aspects of the present invention are now described in an exemplary manner. The area marked with the reference symbol 113 represents the identification document holder or the field of an identification document holder. The identification document holder 113 owns a mobile communication device 102 which is able to enter into wireless communications with at least one broadcasting network. The mobile communication device 102 has a display unit 103, an operating unit 104 as well as an internal memory unit (not shown). The mobile communication device 102 preferably consists of a mobile telephone or a PDA which is suited for mobile communications, wherein the device and process of the present invention can also be utilized with other mobile communication devices. The mobile communication device 102 communicates with the sender 108 through the broadcast connection 106 of a radio cell of a communication network 114.

The communication network 114 is only schematically shown in FIG. 1 and may particularly consist of a mobile broadcasting network or a combination of several mobile broadcasting networks. The exemplary communication network 114 includes several network servers 109, 109′, 109″, and several senders 108, 108′, wherein each sender 108, 108′ forms one or more radio cells of the mobile communication network, in which several mobile communication devices 102′, 102″, 102′″ can be used. The communication network 114 may also include one or more different networks which are linked with each other; for instance, the invention may be utilized with WLAN broadcasting networks or other broadcasting networks. The person skilled in the arts of mobile communication is familiar with a wide variety of networks, so that a detailed description of all possible combinations of networks is not necessary for a comprehensive description of the invention.

The area marked with the reference symbol 112 represents a provider or the area of a provider of an identification document in accordance with the invention. The identification document provider 112 operates a provider server 110 on which there is a central database 111. The identification document provider 112 may, for instance, consist of a credit card company, wherein the central database then contains data about credit card customers, data about licensees as well as data about business bookings. Within this context, licensees are business customers who offer their customers a credit card booking for the payment transactions. The provider server 111 is also suitable for communicating via communication networks, for instance via an internet connection 107. If applicable, the provider's server 110 may also communicate with the control unit of a payment terminal 115 of a licensee through a secure direct data line 120. Other possible data transmission routes are indicated in FIG. 1 with dotted lines.

The area marked with the reference symbol 115 represents a payment terminal of a licensee and includes a cash register 117, a card terminal 119, a scanner 116 and a control unit 118. The control unit 118 may be a common personal Computer which has a microprocessor and a communication unit. The control unit 118 is linked with the communication networks 114, for instance through the internet line 107′, wherein this connection can be used to send data both to the server 110 of the provider and to the mobile communication device 102 of the identification document holder 113. If applicable, the control unit 118 may directly and securely communicate with the provider's server 110 through the direct data line 120.

The mobile communication device 102 of the identification document holder 113 serves as an identification document 101, wherein an identification dataset that is stored in the memory of the mobile communication device 102 contains an identification image 121 which is shown an the display unit 103 when the identification document holder 113 brings up the image of the identification document 121 using the operating unit 104 with menu support. The identification document image 121 may, for instance, include a description of the identification document (e.g., “Megacard”) and a barcode 105 which can be read out with a scanner directly from the display unit 103 of the mobile communication device 102.

FIG. 2 provides an exemplary depiction of the steps which are carried out in the creation of an identification document in accordance with the invention in an exemplary manner in a flow diagram. The area marked with the reference symbol 212 includes the steps which are carried out by the identification document provider, and the area 213 includes the steps which are carried out by the mobile communication device 202 and/or by the identification document holder. The creation of an identification document in accordance with the invention is triggered by a request to create such a document (step 220). The request to create an identification document can be transmitted to the identification document provider in writing, via fax, via e-mail or through entry into a database. In step 221, the identification document provider verifies whether the customer data which are available to him are sufficient to create an identification document. There is also a verification of whether there are other reasons to oppose the creation of an identification document. Such reasons may include—for instance—insufficient credit rating of the customer, a block notice or a suspicion of an abusive request for creating an identification document. If the prerequisites are not all met, the creation of the identification document will be stopped, wherein the negative completion of the inquiry can be communicated to the customer in step 222. If applicable, the report to the customer may also include a request to update his customer data. In particular, the creation of an identification document requires data which allow identification of the identification document holder as well as the unique network identification of the mobile communication device 202 which is assigned to the customer.

If all prerequisites for the creation of an identification document are fulfilled, the server 211 of the identification document provider creates a security code in step 223, wherein the security code preferably consists of a randomly generated series of four characters. In step 224, a bar code which contains all data that are required for the computer supported processing of the identification document is generated. The bar code preferably contains a license code, the unique identification of the mobile communication device 202, a PIN code and one or more test values. A particularly advantageous embodiment of a bar code in accordance with the invention is explained further below in association with the description of FIG. 4.

In step 225, the security code is transmitted to the mobile communication device 202 via SMS and received by the mobile communication device in step 230. Next, an identification image is produced in step 226, and an MMS with the image of the identification document and the bar code is sent to the mobile communication device 202. In step 231, the mobile communication device 202 receives the MMS in step 231, wherein the MMS must be decoded/released by the owner of the mobile communication device using the previously received security code. The activation of the identification document is performed in step 232, in which the identification document holder enters the previously received security code into the mobile communication device. In step 223, the mobile communication device 202 sends a confirmation of activation back to the provider's server 211, wherein the confirmation is received by the server in step 227. In step 228, the identification document that was sent is released on the server side. In step 229, the identification document holder can be informed of die release of the identification document, e.g. by sending an e-mail, letter, SMS etc.

The identification document holder can use the newly issued identification document by bringing up the received MMS and showing the Image of the identification document on the display unit of the mobile communication device. The PIN code which is contained in the bar code 205 can, in the case of high security criteria, be sent to the identification document holder with a separate letter via mail, as this is done, for instance, in the case of credit cards at this time. If applicable, however, the PIN code can also be sent to the identification document holder via email or SMS, or it is possible to use a PIN code which is already known to the identification document holder, for instance the Same PIN code as with a preceding identification document.

The bar code 205 preferably has a code, so that it is not possible to read the secret PIN code out directly from the bar code.

The combination of an identification document that is linked to the person and a mobile communication device that is assigned to the person as well as the use of a bar code or another machine readable code which can be shown optically and into which an encoded PIN code is integrated makes it possible to carry out processes which require a personal confirmation from the identification document holder with automation support at a high level of security.

Such security is, for instance, required in payment processes, wherein FIG. 3 shows an exemplary payment process using a credit card identification document in accordance with the invention. The payment process involves four different units which communicate with each other. The payment process starts (321) at a cash register 317, where the payment is initiated (step 322). The already compiled invoice data, particularly the sum to be paid, are then transmitted from the cash register 317 to a control unit in step 323; the control unit is linked to a scanner 316. In step 324, the control unit 318 activates the scanner 316 in order to use it to read in data. The identification document holder uses his mobile communication device 302 to bring up the identification document and shows the identification document with its bar code in step 325 so that it can be scanned in with the scanner 316 (step 326). In step 328, the control unit 318 decodes the bar code, reads the unique identification of the mobile device that is contained in the bar code out, and checks in step 329 whether the bar code meets the integrity requirements. An integrity test can take place alternatively or additionally in the later step 333 as well. The integrity test takes place using test values which are contained in the bar code, wherein the test values were created using various test algorithms using the actual data that are contained in the bar code. If the test values which are contained in the bar code do not correspond to the formation algorithms, this is an indicator that the bar code might have been manipulated. Using cryptographic measures, it is possible to create the test values so that their integrity can be tested, but it is nonetheless very difficult to find out the formation algorithms.

If the bar code corresponds to the formation algorithms, the control unit 318 then sends a verification question 330 to the mobile communication device 302. The verification question can, for instance, consist of an SMS message with which the identification document holder is asked to enter his secret PIN into the device—e.g. a mobile telephone—302 in step 331. After the PIN has been entered, the mobile telephone 302 sends the PIN—preferably using a secured transmission route—to the control unit 318 (step 332). The control unit 318 uses the PIN which was received from the mobile communication device 302 in step 333 to check whether the PIN code matches the PIN code that is contained in the bar code. The unique identification of the mobile device is known to the control unit 318 due to the verification question 330 which was transmitted to the unique identification of the mobile device 302 and due to the answer from the mobile device 302, so that the identical identifications have ensured that the identification document is being used on the correct mobile device.

After the control unit 318 has therefore checked both the integrity of the identification document and the identity of the identification document holder, transaction codes are generated in step 334 which summarize the data that are required for booking with the credit card company. The transaction code generally contains the identification that is uniquely assigned to the mobile device 302 and a license code which identifies the identification document provider. The transaction code and the invoice data are transmitted to the central server 310 of a credit institute in step 335. Using the transmitted data, the central server 310 checks the credit rating of the identification document holder (step 336). In the case of prepaid cards, it is checked whether the prepaid account of the identification document holder has sufficient coverage to book the payment. It is also checked in step 337 whether there are other reasons which prevent booking. In particular, it is checked whether the central database indicates that the identification document is blocked. If the prerequisites for booking are present, a confirmation of validity 339 is sent to the cash register 317 and the central server 310 initiates booking of the payment transaction (step 338). The payment is also booked in the cash register 317 after the confirmation of validity 339 is received (step 340), which completes the payment process (341).

The payment process which is shown in FIG. 3 contains attributes which guarantee a very high level of payment security. However it is not necessary to utilize all security measures in order to use the benefits of the invention.

The attributes of the payment process shown in FIG. 3 can also be used for other purposes, such as verifying the identity of a person who is stating their identity, e.g. in access or identification checks. In this case, an access control system could be provided instead of the cash register 317. Instead of the invoice data, for instance, data about the time and the circumstances (e.g. the utilized access route) could be transmitted. Herein the central server would check the access authorizations of the person who was stating their identity for the respective time and access route, and initiate a protocol entry instead of a booking.

A person skilled in the arts can easily apply the knowledge from the above process to other processes in which a person with an identification document in accordance with the invention shows an authorization and/or shows that they are enabled, and wherein a system must check the integrity of the identification and the validity of the shown authorizations and/or qualifications. Examples of such processes include the verification of tickets for events, wherein the ticket can lose its validity when the person enters, applying coupons towards wares and services which are provided in the form of an identification document in accordance with the invention, or the use of an identification document for company employees who Show their identity to access systems of the company and/or when using company resources with an identification document in accordance with the invention.

FIG. 4 schematically shows how a bar code 405 can be structured in accordance with the invention. The bar code for an identification document in accordance with the invention includes a license code 420, a country code 421 for the mobile device, a mobile network area code 422 for the network in which the mobile device is operated, a network ID 423 in which the network recognition in the case of mobile telephone networks consists of the telephone number of the mobile telephone, and a PIN code 424. The entire dataset or parts of the dataset are used in a first step with a first algorithm 425 to form a first test value CRC-I (426). The person skilled in the arts is familiar with various processes for forming test values, wherein different processes can also be combined. Examples of this include processes for cyclic redundancy checks, cryptographic HASH functions or secure HASH algorithms.

The second test value CRC-II (428) is formed with a second algorithm 427 and using the entire initial data, including the first test value CRC-I. The two test values CRC-I and CRC-II are additionally transformed into a third test value CRC-III (430) using a third algorithm 429. All three test values are combined (and encoded if applicable) together with the initial data in a fourth algorithm 431 and serve as a basis for the bar code 405. Suitable selection and combination of known formation algorithms can be applied to form a bar code which possesses a high level of security against forgery.

Bar codes offer the advantage that they can be easily read in with simple scanners, wherein many devices, such as cash register terminals or access control terminals, are already equipped with such scanners. In order to change these devices to the devices and processes in accordance with the invention, it is merely necessary to integrate a program applet into the control software of the scanner which, for instance, carries out the program series shown in FIG. 3 for the control unit 318.

The identification documents in accordance with the invention can be used not only for cashless payment, but also for many other forms of identification, wherein the security attributes can also be adapted to the security level that is required for the respective document. Due to the low costs which are incurred in order to produce an identification document in accordance with the invention, the invention also makes it possible to issue identification documents which have a very short period of validity. For instance, coupons which are valid for a limited time period can be transmitted to the identification document holder as identification documents, wherein the coupons lose their validity when they are used or when their validity period expires. In a preferred embodiment of the present invention, identification documents can also be used to regulate access systems, wherein the identification documents are used either for long term use, e.g. as access control systems for employees of a company, or for short term use, e.g. for guest access cards or event tickets.

Some exemplary embodiments of identification documents in accordance with the invention are shown in FIG. 5-8. FIG. 5 shows a customer card that is shown on a mobile communication device 502, containing an identification image 521, which shows a company name 522, a card name 523, the name of the card holder 524 and a bar code 505. The depiction of a separate credit card number is not necessary, since each credit card is assigned to a specific mobile communication device 502 and a specific holder via the unique identification.

The identification document shown on the mobile communication device 502 is a confirmation of identity document, wherein the identification image 621 includes an identification document name 623, a holder name 624, a (stylized) passport photo 625 of the holder and a bar code 605.

FIG. 7 shows an identification document on a mobile device 702 in which the identification image 721 merely shows an identification name 723 and a two dimensional code 705 of the data matrix type. Such a document could be used, for instance, as an (optically readable) key for access control systems.

The identification document which is contained in the mobile communication device 502 in FIG. 8 shows an identification image 821 which shows a fingerprint 805 of the identification document holder next to the identification name 823. The fingerprint 805 replaces the bar code as an optical recognition attribute, wherein the fingerprint 805 can be read in by a scanner and compared to the actual fingerprint of the person who is identifying himself. Such an identification document is, for instance, suitable for applications in which the identity of the holder is of special importance.

Each mobile communication device can be used to store and use a large number of identification documents in accordance with the invention, wherein the possible number of the stored identification documents is practically limited only by the size of the memory of the mobile communication device. In order to simplify the handling of a large number of different identification documents which are stored on a mobile communication device, the mobile communication device can contain a computer program or applet which simplifies the handling of the identification documents with an intuitively operated user interface.

An exemplary embodiment of a user interface for such an administration and handling program is shown in FIG. 9. The program can either be operated using the operating unit 904 of the mobile communication device 902 or operation takes place directly using the display unit 903 that is formed as a touch screen. Herein the identification documents 521, 621, 821 and 721 which are shown on the display unit 903 can be pushed back and forth or leafed through with the finger, using computer animation, until the desired identification document is visible. The document can then be brought forward by tapping it with a finger in order to use it. In order to manage a large number of documents, they can be stored in subfolders, wherein an identification document can be put into a subfolder, for instance, using “drag and drop”. In addition, the documents can be divided into groups, wherein a group can be assigned shared properties, such as shared security features. Such a security measure can, for instance, consist of deactivation of one or more identification documents if the mobile device was not used for a predefined time period. In order to be able to use a deactivated identification document again after a longer period in which the mobile device was not used, the PIN code of the identification document must be entered into the mobile telephone.

The computer program may also include a function to assign the same PIN code to a group of identification documents. For this purpose, the desired PIN code and if applicable, the PIN codes which are already assigned to the identification documents are requested, and the new PIN code is transmitted to the central database using a secure connection. Since the PIN code can be contained in the bar code of the documents, these documents must be reissued by the central database and retransmitted to the mobile communication device when the PIN code is changed. The process explained in association with FIG. 2 is used herein, wherein, if applicable, a single security code can be used for several transmitted identification documents. After the new identification documents are successfully created, the computer program replaces the old identification documents with the new ones.

The computer program can also have a function which supports the user in the re-issuing process for expired identification documents.

Mother attribute of the computer program may consist of a function to transfer identification documents from a previously used mobile device to a currently used mobile device. If the unique identification of the mobile device has also changed in this case, the documents which have an optical recognition attribute that contains the unique identification must also be newly issued by the central server, wherein the computer program can collectively process the re-issuing process for several documents. If the newly used mobile device will be used with the same unique identification as the previously used mobile device, it is possible to copy the datasets of the identification documents from one mobile device to the other mobile device, e.g. using a cable or wireless connection between the two devices, or by exchanging a memory card.

The individual functions of the computer program can be selected using pull down menus 926, by tapping the touch screen or by moving a mouse cursor 927.

In summary the Identification document is linked to a person, particularly for the authentication of authorizations or qualifications of the person, consisting of a mobile communication device which is able to show images and assigned to the person, including a display unit, an operating unit and a memory, wherein an identification dataset that is stored in the memory is assigned to data which are stored and administered in a central database, and wherein an optical recognition attribute that is assigned to the identification dataset can be displayed on the display unit of the communication device.

The identification dataset can consist of a message in accordance with a standard which uses at least one proprietary standard of a provider of mobile communication services.

The identification dataset can consists of a message in accordance with a non-proprietary, open standard.

The identification dataset can consists of a message in accordance with the Multimedia Messaging Service Standard (MMS message) and the optical recognition attribute consists of an image that is contained in the MMS message.

The identification dataset and/or the optical recognition attribute has/have copy protection.

The optical recognition attribute of the identification document can have a machine readable code that can be optically shown.

The Identification document can be realized with a machine readable code that contains at least one license code, a number that is uniquely assigned to the mobile communication device, a PIN code and one or more test values, or the machine readable code is formed out of at least three test values, wherein one test value is calculated on the basis of two other test values.

The Identification document can contain information about access authorizations. The Identification document can contain credit card information. The Identification document can contain an expiration date. The Identification document can be a coupon. The Identification document can be an event ticket.

The Process as outlined can additionally include the step of forming the machine readable code from a license code, a unique number that is assigned to the mobile communication device, a PIN code and one or more test values.

The Process can additionally include the following steps:

change of the PIN code by the person;
transmission of the changed PIN to the central database;
new generation of the machine readable code; and
generation and transmission of a new identification dataset on the basis of the changed data.

The Process can additionally include the step of forming the machine readable code from at least three test values, wherein one test value is at least partially calculated on the basis of two other test values.

The Process can additionally include the steps of transmitting, in a separate process from the transmission of the identification dataset, a message with a security code to the mobile communication device that is assigned to the person, wherein the security code is required in order to activate the identification dataset.

The Process can be realized wherein the identification dataset is encoded and the security code is the code that is required for decoding.

The Process can additionally include the step of transmitting a confirmation of secure receipt of the identification dataset from the mobile communication device to the central database.

The Process can additionally include the step of generating a new identification dataset and transmitting it to the mobile communication device after the expiry of an expiry date that is assigned to the document

The Process can additionally include the step of blocking the identification document in the central database after a report of a theft or loss of the mobile communication device (that is, to mark it as “invalid”).

The Process can additionally include the following steps:

Transmission of a message about the block of the identification document to the mobile device;

deactivation of the identification document and/or the mobile device.

The Process can additionally include the step of deactivating the identification dataset after a specific period during which the mobile communication device has not been used.

The Process can be designed in a manner wherein the deactivated identification dataset is reactivated by entering the PIN code.

The Process can be designed in a manner wherein the duration is selected by the person.

While using the identification document as outlined in the independent use claim, the optical recognition attribute has a machine readable code that can be optically shown, and wherein the use includes the following steps:

the code is read into a payment terminal using a scanner, and the read-in code is transmitted to the central database.

While using the identification document as outlined in the independent use claim, additionally the following steps can be included:

transmission of a verification question from the payment terminal to the mobile communication device;

entry of a PIN code into the mobile communication device;

transmission of a confirmation message from the mobile communication device to the payment terminal.

While using the identification document as outlined in the independent use claim, the central database transmits a message to the mobile communication device about the initiated booking.

While using the identification document as outlined in the independent use claim, the identification dataset can contain a coupon, and the coupon can have a time limited validity.

The Computer program product in accordance with the independent computer program claim can additionally carry out the following steps:

after reading in the machine readable code, transmission of a verification question to the mobile communication device; receiving a verification from the mobile communication device.

The Computer program product in accordance with the independent computer program can be designed in such manner that integrity verification includes the additional step of decoding the read-in code.

The Computer program product in accordance with the independent computer program can be designed in such manner that it can be executed an a mobile communication device that is capable of depicting images and assigned to a person for the administration and handling of identification documents.

The Computer program product in accordance with the independent computer program can be designed in such manner that several identification documents which are assigned to the person can be divided into subfolders or groups.

The Computer program product in accordance with the independent computer program can be possess a function for changing the PIN code.

The Computer program product in accordance with the independent computer program can be design in such manner that the program destroys or deletes identification documents if there is a block prerequisite.

The Computer program product in accordance with the independent computer program can be design in such manner that the block prerequisite consists of a recognition of an attempt to circumnavigate copy protection without authorization.

The Computer program product in accordance with the independent computer program can be design in such manner that the block prerequisite is a message from the central database that the identification document is blocked.

The Computer program product in accordance with the independent computer program can be design in such manner that it temporarily deactivates at least specific identification documents if the mobile device is not used after the expiry of a predefined time period.

The Computer program product in accordance with the independent computer program can be design in such manner that the deactivated identification documents are reactivated by entering a PIN code.

The Computer program product in accordance with the independent computer program can be design in such manner that the program has a function to transfer identification documents from a previously used mobile device to a currently used mobile device

### REFERENCE SYMBOL LIST

Identification document 101
Mobile communication device 102,102′, 102″, 102′″, 202, 302 . . .
Display unit 103
Operating unit 104 . . .
Barcode 105,205 Broadcast connection 106
Internet connection 107, 107′
Sending tower 108, 108′
Network server 109,109′, 109″
Provider's Server 110, 310
Central database 111, 211
Identification document provider 112, 212
Identification document holder 113, 213
Third party provider 114
Payment terminal 115 Scanner 116
Cash register 117
Control unit 118 (contains a microprocessor, a communication unit)
Card terminal 119
Direct date link 120
Identification image 121, 521, 621, 721, 821
Steps FIG. 2: 220-233
Steps FIG. 3: 321-341
License code 420
Country code 421
Mobile network area code 422
Network ID 423
PIN code 424
CRC I-III: 426, 428, 430
Algorithm 1-4: 425, 427, 429, 431
Identification image 521, 621, 721, 821
Company name 522
Identification name 523, 623, 723, 823
Holder name 624
Photo of the person 605
2D code 705
Fingerprint 805
Touch screen 903
Operating unit 904
Pull down menu 926
Mouse cursor 927

What is claimed is:

1. Identification document which is linked to a person, particularly for the authentication of authorizations or qualifications of the person, consisting of a mobile communication device which is able to show images and assigned to the person, including a display unit, an operating unit and a memory, wherein an identification dataset that is stored in the memory is assigned to data which are stored and administered in a central database, and wherein an optical recognition attribute that is assigned to the identification dataset can be displayed on the display unit of the communication device.

2. Identification document in accordance with claim 1, wherein the optical recognition attribute is the image of an identification document.

3. Identification document in accordance with claim 1, wherein the optical recognition attribute contains a photo of the person.

4. Identification document in accordance with claim 1, wherein the mobile communication device is a mobile telephone.

5. Identification document in accordance with claim 1, wherein the mobile communication device is a PDA that is suitable for communication.

6. Identification document in accordance with claim 1, wherein the mobile communication device is a cordless telephone.

7. Identification document in accordance with claim 1, wherein the mobile communication device is a radio unit.

8. Identification document in accordance with claim 1, wherein the identification dataset and/or the optical recognition attribute can be digitally transmitted.

9. Process for the production of an identification document that is linked to a person, particularly for authenticating authorizations or qualifications of a person, wherein an identification dataset that is stored in the memory of a mobile communication device that is able to display images is assigned to data which are stored and administered in a central database, and wherein an optical recognition attribute that is assigned to the identification dataset can be shown on the display unit of the communication device, and the process has the following steps:
entry, updating and completion of personal data in a central database;
creation of an identification dataset with an optical recognition attribute on the basis of the personal data;
secure transmission of the identification dataset to a mobile communication device that is assigned to the person;
activation of the identification dataset by the person; and
display of the optical recognition attribute on a display unit of the mobile communication device.

10. Process in accordance with claim 9 which additionally includes the steps of generating a machine readable code that can be optically shown on the mobile device and embedding the code into the optical recognition attribute.

11. Process in accordance with claim 9 which additionally includes the steps of transmitting, in a separate process from the transmission of the identification dataset, a message with a security code to the mobile communication device that is assigned to the person, wherein the security code is required in order to activate the identification dataset.

12. Process in accordance with claim 9 which additionally includes the step of transmitting a confirmation of secure receipt of the identification dataset from the mobile communication device to the central database.

13. Process in accordance with claim 9 which additionally includes the step of generating a new identification dataset and transmitting it to the mobile communication device after the expiry of an expiry date that is assigned to the document

14. Process in accordance with claim 9 which additionally includes the step of blocking the identification document in the central database after a report of a theft or loss of the mobile communication device (that is, to mark it as “invalid”).

15. Process in accordance with claim 9 which additionally includes the step of deactivating the identification dataset after a specific period during which the mobile communication device has not been used.

16. Use of an identification document that is linked to a person for cashless payment, wherein an identification dataset which is stored in the memory of a mobile communication device which is able to show images and assigned to the person is assigned to data which are sorted and administered in a central database, and wherein an optical recognition attribute that is assigned to the identification dataset can be shown on the display unit of the mobile communication device, and wherein the use includes the following steps:
the owner of the communication device which shows the identification document must show the communication device when making a payment;
the data which are displayed on the optical recognition attribute are transmitted to the central database;
the payment is booked to the central database.

17. Use in accordance with claim 16, wherein the identity and/or the credit status of the person is checked online before the payment is booked.

18. Use in accordance with claim 16, wherein a check is carried out online prior to booking the payment in order to verify whether the identification document is blocked in the central database after a report of theft or loss of the mobile communication device (that is, marked as invalid).

19. Computer program which can run on a microprocessor for the purposes of validating a machine readable code that can be optically shown on a mobile communication device that is able to display images and is assigned to a person, including at least one license code, a number that is uniquely assigned to the mobile communication device, a PIN code and one or more test values, wherein the microprocessor is connected at least to a scanner and a communication device, and the program executes the following steps:
receiving a validation question from an external application through the communication device; reading in the machine readable code using the scanner;
verifying the integrity of the machine readable code; and
transmitting a confirmation of validity to the external application.

20. Computer program product in accordance with claim 19 which additionally carries out the following steps:
receiving invoice data from the external application;
extraction of a license code and a number that is uniquely assigned to the mobile communication device from the machine readable code;
forming a transaction code from the license code and the uniquely assigned number; and transmission of the transaction code and the invoice data to a central database.
